(19) United States
(12) Patent Application Publication
(10) Pub. No.: US 2009/0223494 A1
(43) Pub. Date: Sep. 10, 2009

(54) Internal combustion oxygen injection process

(76) Inventor: Watts Fredrick Williamson, Florence, MS (US)

Correspondence Address: Watts Fredrick Williamson, P.O. Box 54, Florence, MS, 39073, US

(21) Appl. No.: 12/075,271

(22) Filed: Mar. 10, 2008

(51) Int. Cl. F02M 25/10; F02M 25/00

(52) U.S. Cl. 123/567; 123/1 A

(57) ABSTRACT

Oxygen can make any fuel more flammable, more powerful and burn more efficiently. When oxygen is mixed with the normal air that enters the air intake of an internal combustion engine, the engine runs faster and creates more power using the same amount of fuel. Because more fuel is burned, there are less exhaust fumes and the engine runs cleaner. Due to the high cost of oxygen, the Internal Combustion Oxygen Injection Process would not be practical or feasible cost wise. The answer to the Internal Combustion Oxygen Injection Process is using an oxygen concentrator which concentrates oxygen from the air around us. There is a control value on the oxygen concentrator that regulates the liters per minute of oxygen that it produces. This makes it possible to regulate the amount of oxygen needed for every type of internal combustion engine.

### BACKGROUND OF PROCESS:

The Internal Combustion Oxygen Injection Process was invented because of the high price of fuel for internal combustion engines.

### SUMMARY OF PROCESS

By mixing oxygen with the normal air that goes into the air intake of an internal combustion engine, the revolutions per minute and the power of the internal combustion engine can be increased without increasing the amount of fuel used.

### BRIEF DESCRIPTION OF DRAWINGS

FIG. 1 is a drawing of the Internal Combustion Oxygen Injection Process using an oxygen tank. On the top of the tank is an on-off value, a tank outlet, a regulator to regulate pressure, and a pressure value to regulate the flow of oxygen by liters per minute. A hose is connected from the pressured value to the air intake of the engine. When the oxygen is mixed with the normal air entering the air intake of the engine, the revolutions per minute of the engine will increase without increasing the amount of fuel used. This will allow the car to go further on the same amount of fuel. The oxygen tank can be put in the trunk of the car.

FIG. 2 is a drawing of the Internal Combustion Oxygen Injection Process using an oxygen concentrator. The oxygen concentrator has an on-off switch, an exhaust for the nitrogen, an air inlet for normal air to enter, an oxygen outlet for the concentrated oxygen to exit and a value to control the flow of oxygen from the oxygen outlet by liters per minute. A hose is connected from the control value to the air intake of the engine. When the oxygen is mixed with the normal air entering the air intake of the engine, the revolutions per minute of the engine will increase without increasing the amount of fuel used. This will allow the car to go further on the same amount of fuel. The oxygen concentrator can be put in the trunk of the car, but it needs a fresh air inlet and an exhaust outlet.

### DETAILED DESCRIPTION OF PROCESS

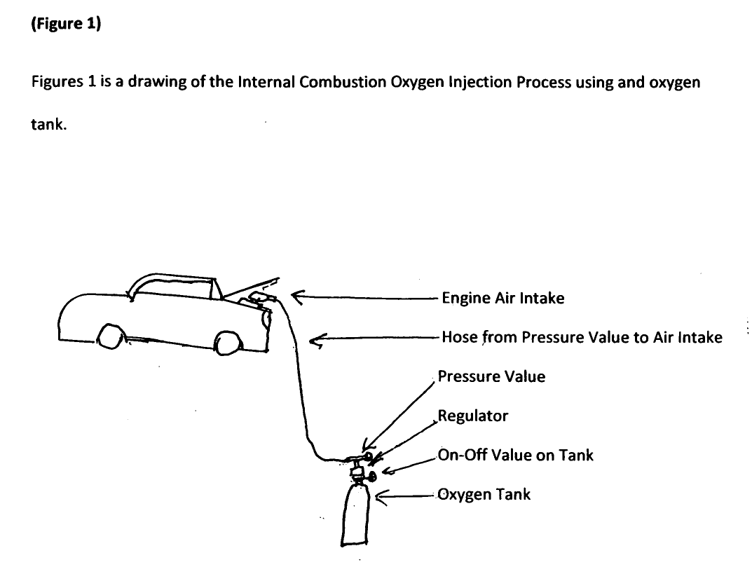

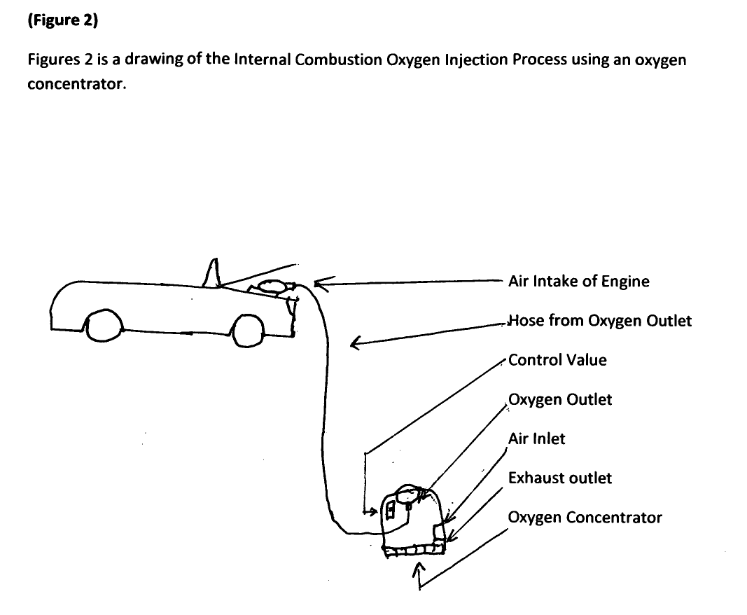

The Internal Combustion Oxygen Injection Process injects oxygen into the air intake of an internal combustion engine. This oxygen is mixed with the normal air that goes into the air intake and increases the oxygen level of the air entering the air intake of the internal combustion engine. As the amount of oxygen is increased and mixed with the normal air entering the air intake of the internal combustion engine, the power and revolutions per minute of the internal combustion engine increases without increasing the amount of fuel used. This results in more miles per gallon of fuel for an internal combustion engine in an automobile. It also results in using less fuel to obtain a certain amount of revolutions per minute of any internal combustion engine. Oxygen can be mixed with the normal air entering the air intake of an internal combustion engine by running a tube from the oxygen source to the air intake. The amount of oxygen to be mixed with the normal air can be controlled with a pressure value at the oxygen source. If a tank of pressurized oxygen is used, a pressure regulator and a pressure value must be used to regulate the amount of oxygen to be mixed with the normal air going into the air intake of an internal combustion engine (refer to FIG. 1 drawings). To make the Internal Combustion Oxygen Process cost efficient, an oxygen concentrator must be used. When an oxygen concentrator is used, there will be very little cost for the oxygen. An oxygen concentrator concentrates the oxygen from the normal air in the atmosphere. The oxygen concentrator is used in the medical industry to supply oxygen to people who need to breathe oxygen. An oxygen concentrator can supply oxygen at a constant pressure. An oxygen concentrator has a control value to control the liters of oxygen per minute that is supplies. The oxygen concentrator has an outlet that a hose or tube can be connected to. This hose or tube can be inserted into the air intake of an internal combustion engine. The amount of oxygen to be mixed with the normal air going to the air intake of the internal combustion engine can be regulated with the control value on the oxygen concentrator (refer to FIG. 2 of drawings).

1. I claim a process of increasing the power and revolutions per minute of the Internal Combustion Engine without increasing fuel used by mixing oxygen from an oxygen concentrator with the normal air that goes into the air intake of the Internal Combustion Engine.

2. I claim that when an oxygen concentrator is used in the process of claim 1, there will be very little cost for the oxygen.

3. I claim that by using the process of claim 1, there will be less harmful emissions from the exhaust of the Internal Combustion Engine.
